(19) United States
(12) Patent Application Publication
(10) Pub. No.: US 2005/0163993 A1
(43) Pub. Date: Jul. 28, 2005

(54) Decorative film-like material

(76) Inventor: Shigeo Kawabata, Osaka-shi (JP)

Correspondence Address: MERCHANT & GOULD PC, P.O. BOX 2903, MINNEAPOLIS, MN, 55402-0903, US

(21) Appl. No.: 11/045,692

(22) Filed: Jan. 28, 2005

Related U.S. Application Data
(63) Continuation-in-part of application No. 10/375,695, filed on Feb. 26, 2003, now abandoned.

(51) Int. Cl. B32B 3/00; B60R 13/00

(52) U.S. Cl. 428/336; 428/187; 427/255.31

(57) ABSTRACT

The present invention relates to a decorative film having a plating toned metallic luster. A decorative film has a primer layer including a cross-linking agent, a decorative layer including a metal thin film with a thickness of less than 10tm on the primer layer, and further a curable resin layer which is a layer cured by radiation thereon. The manufacturing method includes at least the first process to print a primer layer on a releasing surface of a releasing sheet for transfer, wherein the primer layer includes a cross-linking agent and a resin having a releasing property to the releasing sheet; the second process to from a metal thin film with a thickness of less than 10 μm as a decorative layer on the primer layer by either a spattering method or a vacuum evaporation method the third process to coat a curable resin coating cured by radiation on the decorative layer formed on the primer layer in a state of applying the releasing sheet thereon; and the forth process to transfer the primer layer and the decorative layer from the releasing sheet to the curable resin layer to form a decorative film when the coated curable resin coating is cured to form a cured resin layer.

### CROSS-REFERENCE TO RELATED APPLICATION

This application is a Continuation-In Part application of, and claims priority from, U.S. patent application Ser. No. 10/375695 entitled “Decorative Film-Like Material” filed on Feb. 26, 2003.

### BACKGROUND OF THE INVENTION

1. Field of the Invention

The present invention relates to a decorative film which can be preferably used when the effect of mirror surface is required as a design for construction components including exterior walls, street doors and exteriors and interiors of vehicles and vessels, billboards and signs. It also relates to an automobile with the decorative film, automobile parts with the decorative film and a method of manufacturing the decorative film.

2. Description of Related Art

The following description sets forth the inventor's knowledge of related art and problems therein and should not be construed as an admission of knowledge in the prior art.

For example, in order to improve the design of constructions component, such as exterior walls, street doors and exteriors and interiors of vehicles and vessels, billboards and signs, a decorative sheet with color, etc. is adhered thereon or a decorative film is bonded to a substrate thereof.

Heretofore, as decorative layers and decorative films excellent in design with good operational efficiency, decorative coating film with a film body provided which is composed of a printing layer printed on a releasing surface of a releasing sheet and having a releasing property to a releasing surface and a coated layer formed by a kind of curable resin coatings selected from the group consisting of a resin coating cured by heat, a resin coating cured by electron rays, a resin coating cured by radiation, and a resin coating cured by ultra violet rays cured after coating in such a way as to cover a surface of the printing layer have been suggested (Japanese Unexamined Laid-open Patent Publication 2001-1483).

According to the aforementioned technology, a decoration of a substrate can be easily performed at operational sites by bonding or adhering the decorative film, which is excellent in design and abrasion-resistance, on the substrate.

In the aforementioned technology, in cases where metallic luster is to be given to the decorative film, it is considered to form a printed layer by using metal pigments and the binder components in the printing process.

However, in the print layer of the decorative film obtained by the aforementioned method, since the individual metal particles are simply bonded by the binder components, even in cases where a mirror surface effect is desired, the print layer becomes a metallic tone due to the irregular reflection by the metal particles in the print layer. Therefore, a decorative film having a plating tone cannot be obtained.

In this specification, a metallic tone is defined as providing a feeling of a metal surface with a coated film by applying a coating including metal powder pigments. On the other hand, a plating tone is defined as providing a feeling of a uniform metal surface without diffuse reflection obtained by reflection of metal thin films.

Further, it was difficult to make a thickness of a print layer not greater than 10 μm to print layers having a metal evenly by a printing process. Thus, with the above technology, it has been impossible to manufacture decorative films with good designs having a metal reflection effect while maintaining transparency as well.

Therefore, in order to obtain a decorative film having a plating tone effect using a manufacturing method of the above technology, it is assumed to print only a layer called a foundation layer disclosed in the above document in the above mentioned printing process thereafter forming a metal thin film by using an electrolytic plating method or a usual forming method of metal thin films.

However, in order to adopt an electrolytic plating method, it is necessary to make a releasing sheet for transfer conductive and further, it is necessary not to let a foundation layer dissolve in electrolytic solution. Further, large scale devices must be provided and thus, it is not effective in view of cost effectiveness.

On the other hand, even though efforts are made to form a metal thin film by simply forming a metal thin film on a foundation layer by adopting method of metal thin films including a spattering method or a vapor deposition method, since a foundation layer repels spattered metal or deposited metal, a metal thin film has not been formed. Even in trying to solve this problem by enhancing accelerating energy of ion particles in a spattering method, for example, since spattered metal particles pass through a foundation layer and metal is built up directly on a releasing sheet for transfer, it is impossible to transfer a metal thin film on a decorative film and so such a decorative film could not be obtained to the last.

Therefore, with such decorative films as obtained by the above technology, it has been difficult to apply for exterior and interior of vehicles and vessels including automobile mirror parts, automobile bumper parts, automobile bodies, and the like, in which a plating tone effect as a design is particularly required.

It is an object of the present invention to provide a decorative film excellent in design, abrasion resistance and workability at operational sites, more specifically, a decorative film having a plating-like design.

It is another object of the present invention to provide an automobile parts with the aforementioned decorative film.

It is still another object of the present invention to provide an automobile with the aforementioned decorative film.

It is still yet another object of the present invention to provide a method of manufacturing the decorative film.

### SUMMARY OF THE INVENTION

According to the first aspect of the present invention, A decorative film, comprises:
a primer layer including a cross-linking agent;
a decorative layer formed on the primer layer; and
a curable resin layer formed on the decorative layer,
wherein the decorative layer includes a metal thin film with a thickness of less than 10 μm and the curable resin layer is a layer cured by radiation.

In the present invention, the radiation means ultra violet rays, electron rays, corpuscular rays or the like to the resin layer.

Furthermore, the decorative film is formed of which the primer layer having a releasing sheet for transfer on the backside thereof contains a resin having a releasing property to the releasing sheet and of which the primer layer with the decorative layer transfers from the releasing sheet to the curable resin layer formed on the backside of the curable resin layer after coating and curing as to cover a surface of the decorative layer.

A method for manufacturing a decorative film comprises:
the first process to print a primer layer on a releasing surface of a releasing sheet for transfer, wherein the primer layer includes a cross-linking agent and a resin having a releasing property to the releasing sheet;
the second process to from a metal thin film with a thickness of less than 10 μm as a decorative layer on the primer layer by either a spattering method or a vacuum-evaporation method;
the third process to coat a curable resin coating cured by radiation on the decorative layer formed on the primer layer in a state of applying the releasing sheet thereon; and,
the forth process to transfer the primer layer and the decorative layer from the releasing sheet to the curable resin layer to form a decorative film when the coated curable resin coating is cured to form a cured resin layer.

In addition, instead of the spattering method, a metal thin film may be formed by a vacuum evaporation method.

Furthermore, the present invention relates to automobiles and automobile parts on which the decorative film is adhered.

According to the aforementioned decorative film and a method for manufacturing the same, a decorative film with a plating-like design or a decorative film having a metallic luster while maintaining transparency, which have not been realized by a technology disclosed in Japanese Unexamined Patent Publication 2001-1483, can be obtained. In addition, the present invention can provide an effective method of manufacturing such a decorative film.

Other objects and the features will be apparent from the following detailed description of the present invention with reference to the attached drawings.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWING

The accompanying figures are provided by way of example, without limiting the broad scope of the invention or various other embodiments, wherein:

FIG. 1 is a sectional view showing a decorative film in an embodiment of the present invention;

FIGS. 2(a) to 2(d) are sectional views showing a process flow of a manufacturing method of a decorative film in an embodiment of the present invention;

FIG. 2(a) is a sectional view showing the first process of a manufacturing method of a decorative film in an embodiment of the present invention;

FIG. 2(b) is a sectional view showing the second process of a manufacturing method of a decorative film in an embodiment of the present invention;

FIG. 2(c) is a sectional view showing the third process of a manufacturing method of a decorative film in an embodiment of the present invention; and

FIG. 2(d) is a sectional view showing the fourth process of a manufacturing method of a decorative film in an embodiment of the present invention.

### DETAIL DESCRIPTION OF THE PREFERRED EMBODIMENTS

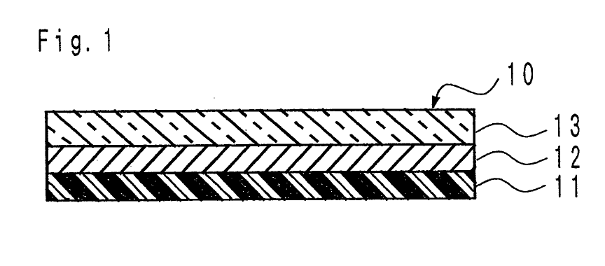

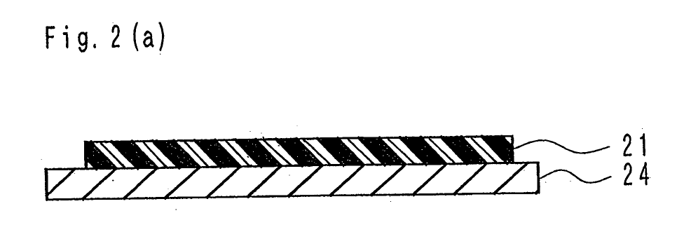

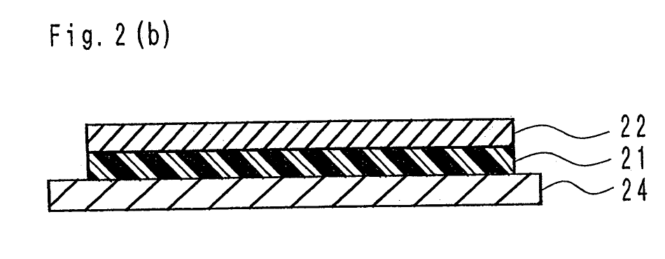

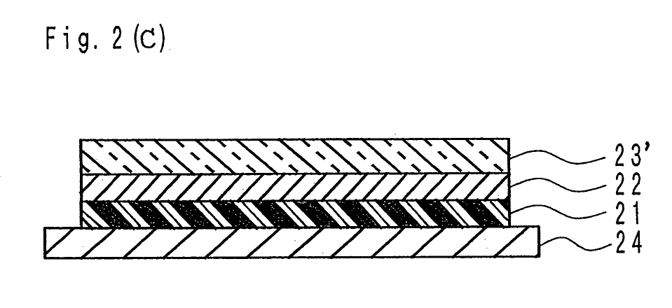

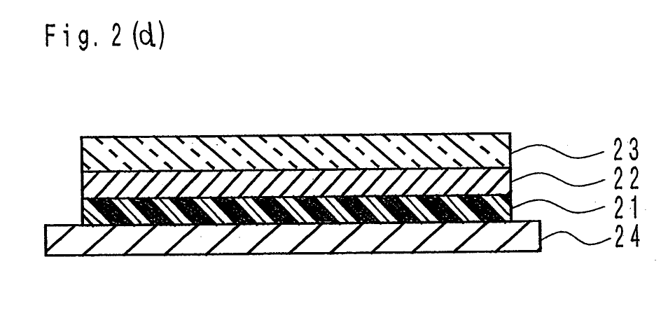

A decorative film according to embodiments of the present invention will be explained with reference to FIGS. 1 and 2.

The decorative film 10 has a primer layer 11, a decorative layer 12 formed on the primer layer 11 and a curable resin layer 13 formed on the decorative layer 12. The decorative layer 12 is formed by curing a curable resin applied on a surface of the decorative layer 12 so as to cover the surface by radiation. The decorative layer 12 includes a metal thin layer.

The primer layer 11 contains a cross-linking agent. The primer layer 11 is preferably formed on a releasing surface of a releasing sheet for transfer 24 and has a releasing property to the releasing surface. Therefore, it is required that the primer layer 11 has a good releasing property to the releasing sheet for transfer 24 and a property for easily building up a metal thin film as a decorative layer thereon. The primer layer 11 may be made of, for example, a polyester resin, an alkyd resin, an amino resin, an acrylic resin, an epoxy resin or a vinyl chloride resin. In cases where resins having compatibility are used for the primer layer 11, these resins can be mixed or can be used in a state of built-up layers.

On the other hand, a silicon resin and a fluoride resin having small surface tension are not suitable for the resin constituting the primer layer 11, although a releasing property to a releasing sheet can be obtained by selecting an appropriate material of the releasing sheet, since it is difficult to form a metal thin film thereon even if a cross-linking agent, which will be explained later, is added to such a resin.

The thickness of the primer layer 11 is not specifically limited. The preferable thickness is about 0.3 to 50 μm because of the following reasons. If the thickness of the primer layer 11 exceeds the upper limit, the flexibility of the decorative film 10 deteriorates. Therefore, in cases where the decorative film 10 is applied to a substrate having an uneven surface, the decorative film 10 may not be well fitted to the substrate. On the other hand, if the thickness of the primer layer 11 is less than the lower limit, the releasing property to the releasing sheet for transfer deteriorates. It is more preferable that the thickness falls within the range of 1 to 10 μm.

The primer layer 11 contains a cross-linking agent for enabling a building up of a metal thin film 12 causing a metal plating-like design effect thereon. As the cross-linking agent, isocyanate cross-linking agents, epoxy cross-linking agents and aluminum chelate cross-linking agents can be exemplified.

Although the detailed mechanism that the cross-linking agent mixed in the primer layer 11 enables the metal thin film 12 to be built up on the primer layer 11 is not clear, it is assumed that the cross-linking agent enhances a capture of metal particles by the three dimensional structure formed by molecular chains constituting the primer layer 11.

In order to obtain a plating-like design effect to be observed from the curable resin layer side 13, the decorative layer 12 may be a metal thin film formed by a known method of making a metal thin film such as a spattering method or a vapor deposition method. In this case, the metal is not limited to a specific one so long as it is capable of forming a metal thin film. Especially, a spattering method can be preferably adapted because any metal can be used to form a metal thin film even if it is a low vapor pressure metal. Examples of such metals include chrome, aluminum, titanium, gold and silver. In addition, an alloy including several kinds of metals can be used. By selecting the kind of metal, a colorless or colored metallic luster caused by the color of the metal can be obtained.

The thickness of the decorative layer 12 is not specifically limited. In cases where a metal thin film is used as the decorative layer 12, however, the thickness of the metal thin film is not required to be 10 μm thick or more since a plating-like design can be obtained even if the thickness is about a few μm. In cases where the decorative layer 12 is formed by a spattering method or a vapor deposition method, a thickness less than 10 μm, which was difficult to obtain by a printing method, can be easily obtained. Thus, a decorative film 12 having a thickness of 0.1 μm or less and a specific transparent design with a metal reflection effect can be obtained.

In the process of forming a metal thin film, by adopting a blocking plate with a specific configuration/pattern, a layer having a plating-like design effect can be formed only in a required portion.

Furthermore, the decorative layer 12 may be a combination of a metal thin film and a print layer formed on the metal thin film formed by a printing method with ink. In this case, when in use, a specific design caused by the combination of the metal thin film and the printing layer can be observed from the curable resin layer side. As for the ink to be used for the print layer, any known ink can be used. For example, acrylic resin ink, fluoride resin ink, inorganic resin in or the like can be exemplified. In this process, since the printing is conducted after forming the, metal thin film, a fluoride resin or the like can be used.

As for a resin used for the aforementioned curable resin layer 13 formed on the decorative layer 12, any known resin can be used as long as it is a non-solvent type curable resin. For example, simple substance of light-cured olygomers having double bond including acrylic group, methacrylic group, allyl group and vinyl group (for example, urethane acrylate resin) and monomers (for example, tripropylene glycol diacrylate) or compounds thereof are preferably used as main components. From a view point of designs in which the patterns of the decorative layer 12 and the like can be clearly observed, it is preferable that the curable resin layer 13 is transparent. However, the decorative film 10 may be colored transparency including coloring components. The coloring components may be any known pigments.

Furthermore, as required, ultra violet ray absorbent, other light stabilizer, anti-oxidant, anti-aging agent, leveling agent, anti-static agent, fixing agent, plasticizer, lubricant, inorganic filler, organic filler, such metal (compound) oxide fine particles including titanium oxide, zinc oxide, ITO and the like having ultra violet ray absorption power or near-infrared ray absorption power can be added as additives in the curable resin layer 13.

The curable resin layer 13 may be constituted by built up layers. In this case, these layers may contain different coloring components respectively. In cases where the curable resin layer 13 is comprised of multiple layers each having different coloring components, the design can further be improved. Also, an additional metal thin film may be provided on the surface of the curable resin layer 13.

It is preferable that the thickness of the curable resin layer 13 falls within the range of 5 to 500 μm. If the thickness of the curable resin layer 13 is less than 5 μm, the protection effect of the decorative layer 12 becomes insufficient. On the other hand, if the thickness exceeds 500 μm, the flexibility of the decorative film 10 deteriorates, resulting in poor handling. It is more preferable that the thickness is 10 to 300 μm.

The method of forming the curable resin layer 13 is not specifically limited. For example, the curable resin layer 13 can be formed by applying a curable resin compositions on the surface of the decorative layer 12 to form a curable resin layer having a predetermined thickness and then irradiating ultra violet rays, electron rays, radiation or the like to the resin layer. The application of the curable resin components onto the surface of the decorative layer 12 can be performed by a bar coat method, a roll coat method, an air doctor coat method, a blade coat method, a squeeze coat method, an air knife coat method, a reverse roll coat method, a gravure coat method, a transfer coat method, a fountain coat method, a slit die coat method or a lip die coat method. In cases where an electron-curable resin is used as the curable resin, an electron irradiation device to be used is not specifically limited. For example, a Van der Graaff scanning type electron irradiation device, a double scanning type electron irradiation device or a curtain beam type electron irradiation device can be used. Especially, it is preferable to use a curtain beam type electron irradiation device which is relatively low in cost and has a strong electron radiation output. Depending on the thickness of the curable resin layer, the acceleration voltage should be adjusted. The electron irradiation atmosphere should be performed in an inert gas atmosphere, such as a nitrogen gas atmosphere, in which oxygen, ozone or the like is not contained.

It is preferable that the acceleration voltage at the time of the electron irradiation is 100 to 500 kV. In order to increase the electron transmission rate, the acceleration voltage is preferably 250 kV or more. The electron absorption dose is not specifically limited as long as the electron-curable resin compositions can be cured in a predetermined degree. Generally, the absorption dose is 0.1 to 7 Mrad, more preferably 0.2 to 5 Mrad. If the electron absorption dose is less than 0.1 Mrad, the curing of the resin composition by the electron irradiation is insufficient. On the other hand, if the electron absorption dose exceeds 7 Mrad, the seat-like substrate may be deteriorated or the color may be changed. Furthermore, it is not preferable from a view point of energy saving.

The surface of the curable resin layer 13 may be covered by a protection film. The protection film is not limited to a specific one as long as the film has an easy-to-peel-off property to the curable resin layer 13 and the material is not likely to migrate with the resin constituting the curable resin layer 13. For example, the protection film may be constituted by a resin film made of polyethylene or polyethylene terephthalate (PET) and a releasing layer including a releasing agent coated on the curable resin layer 13.

As for the releasing sheet for transfer 24 on which the aforementioned decorative film 10 is temporarily adhered, it is not specifically limited as long as the primer layer 11 can be easily released from the releasing sheet 24. The examples of the releasing sheet 24 include a paper substrate such as a quality paper, a coated paper, a cast coated paper and an art paper, a film-like synthetic resin sheet such as a synthetic paper, a polyethylene sheet, a polypropylene sheet, a polyester sheet, a polyamide sheet and a polyvinyl chloride sheet, a laminated paper with polyolefin resin layers formed on one surface or both surfaces, one of the aforementioned sheet on which a releasing layer is provided on the releasing surface and one of the aforementioned sheet whose releasing property is modified by corona treatment. In other words, the releasing sheet 24 may be a sheet having appropriate bonding/releasing properties to the primer layer 11.

Furthermore, the aforementioned decorative film 10 can include an additional adhesive layer (not shown) in the side of the primer layer 11 and a releasing sheet (not shown) for protecting adhered on this adhesive layer. The adhesive constituting the adhesive layer may be a known adhesive. The examples include acrylic adhesive which contains both acrylic polymer and tackifier. The releasing sheet is not specifically limited as long as it is not bonded to the adhesive, and may be a film type sheet made of, for example, a polyethylene terephtalate, a polyethylene or a polypropylene or a paper-like sheet including a quality paper and kraft paper on which a releasing agent including silicon is coated.

When in use, in cases where the decorative film 10 is supplied with the aforementioned releasing sheet, a bonding agent is applied to the primer layer 11 of the decorative film 10 from which the releasing sheet was released, or an adhesive is applied to a substrate surface to which the decorative film 10 is to be adhered. Thereafter, the decorative film 10 from which the releasing sheet was released is fitted on a substrate surface to thereby be integrally adhered thereon via the adhesive.

This decorative film 10 can be used as a pointless film used for a blow molding method, an insert molding method, a film in molding method, a SMC molding method, a PFM molding method, and the like.

On the other hand, in cases where the decorative sheet is supplied with the aforementioned additional adhesive layer provided on the releasing surface of the primer layer 11 and the aforementioned peel-off sheet (not shown) adhered on the additional adhesive layer, it can be used by peeling off the protective sheet and adhering to a substrate via the additional adhesive layer.

(Production Method)

Next, a preferable method for easily manufacturing the decorative film 10 according to the present invention will be detailed with the reference to FIG. 2.

As a preferable process for manufacturing the film 10, a cross-linking agent is mixed to a resin constituting the primer layer 21 as above mentioned. The mixing method may be any known method. It is preferable that the mixing ratio of the cross-link agent to the resin falls within the range of 0.02 to 6%. If the mixing ratio is lower than the lower limit, it becomes impossible to form a metal thin film on the primer layer 21. On the other hand, if the mixing ratio exceeds the upper limit, it becomes difficult to release the film 10 from the releasing sheet for transfer.

In the first process for manufacturing the decorative film 10 of the present invention, as shown in FIG. 2(a), a resin including a cross-linking agent is printed on a releasing surface of a releasing sheet for transfer 24 to thereby form a primer layer 21.

In the second process, as shown in FIG. 2(b), the material obtained in the first process is disposed in a vacuum atmosphere, and a metal thin film as the decorative layer 22 is formed on the primer layer 21 by a spattering method. This process can be performed at the degree of vacuum of about 10⁻¹ Pa since the degree of vacuum at this process can be the same as the conditions for forming a usual metal thin film. Although the metal thin film forming speed depends on metals, it is preferable that the forming speed is about 0.1 to 20 μm/minute. If the forming speed exceeds the upper limit, spattered metal particles go through the primer layer 21 to be formed directly on the releasing sheet for transfer 24. On the other hand, if the speed is lower than the lower limit, the operational efficiency becomes poor.

Further, instead of the aforementioned second process, a vacuum evaporation deposition method can be applied for the second process. As shown in FIG. 2(b), the releasing sheet for transfer 24 with the primer layer 21a obtained in the first process is disposed in a vacuum atmosphere, and a metal thin film as the decorative layer 22 is formed on the primer layer 21 by a vapor deposition method. This process can be performed at the degree of vacuum of about 10⁻³ Pa since the degree of vacuum at this process can be the same as the conditions for forming a usual metal thin film. Although the metal thin film forming speed depends on metals, it is preferable that the forming speed is about 0.1 to 5 μm/minute. If the forming speed exceeds the upper limit, spattered metal particles go through the primer layer 21 to be formed directly on the releasing sheet for transfer 24. On the other hand, if the speed is lower than the lower limit, the operational efficiency becomes poor.

In cases where the decorative film 22 is constituted by a metal thin film and a print layer, the print layer can be formed by printing a resin containing a coating on the surface of the metal thin film by a known printing process.

In the third process, as shown in FIG. 2(c), a radiation-curable resin is coated on the material obtained in the second process on the condition of applying the releasing sheet for transfer. For example, in the case of using a electron-curable resin, non-solvent type electron-curable resin coating 23′ which will form the curable resin layer 23 on the decorative layer 22.

In the fourth process, as shown in FIG. 2(d), the non-cured resin obtained in the third process is cured. For example, in the case of using the non-solvent type electron-curable resin coating 23′, the intermediate obtained in the third process in a non-cured state is disposed in an electron irradiation device, and electron is irradiated to the material to thereby form a cured resin layer 23. When the curable resin coating 23′ which is coated is cured to form a cured resin layer 23, the primer layer 21 and the decorative layer 22 is transferred from the releasing sheet for transfer 24 to the cured resin layer 23.

By releasing the releasing sheet for transfer 24 from the material obtained by the aforementioned process, the decorative film 10 can be obtained. In order to obtain an adhesive layer in this decorative film 10, an adhesive is applied to a releasing sheet, then this releasing sheet with an adhesive is adhered to the primer layer side of the decorative film 10 and heated curing at a temperature of 50° C. for three (3) days, a decorative sheet using the decorative film 10 of the present invention can be obtained.

Since the decorative film 10 obtained by the method explained above is excellent in design, abrasive resistance and workability at operation sites and is a decorative film suitably used when a plating-like design is required, the decorative film of the present invention can preferably be used not only for construction components including walls, columns and doors, for billboards or signs as well as exteriors and interiors of vehicles and vessels including automobile mirror parts and bumper parts, or bodies, and the like.

### EXAMPLES

Hereinafter, the examples of the present invention will be explained in detail.

### Example 1

Aromatic isocyanate as a cross-linking agent (trade name: L-55 E, manufactured by Nippon Polyurethane Industry Co., Ltd) was mixed to an acrylic resin with substantial ratio of 1%. Then, a resin component containing the cross-linking agent was solidly printed on a whole surface of a releasing surface of a releasing sheet with releasing auxiliary layer provided on a surface of a 32 μm thick untreated polyester film (manufactured by Toyobo Co., Ltd) to thereby form a 4 μm thick primer layer.

Next, this sheet was placed in a spattering device and a decorative layer was manufactured by building up silver in 1 μm thick on this primer layer by a spattering method with a building up speed of 10 μm/minute in a vacuum state of 2×10⁻¹ Pa. This sheet with the decorative layer was taken out and a transparent non-solvent type electron ray resin coating (main component thereof is a compound of urethane acrylate resin and tripropylene glycoldiacrylate manufactured by SANYU-PAINT Co., Ltd) was applied on the decorative layer by a gravure coating method to form a resin coating layer of a thickness of 75 μm.

Then, in a state where a polyester emboss film (manufactured by Toyobo Co., Ltd) as a protection film having an uneven surface was fitted on the resin coating layer with the uneven surface fitted on the resin coating layer, this sheet was disposed in an electron ray irradiation device (manufactured by NISSIN ELECTRIC CO., LTD, with a curtain beam method) in a nitrogen gas atmosphere, and 4 Mrad electron ray with an acceleration voltage of 250 kV was irradiated thereto so as to cure the resin layer to thereby obtain a cured resin layer. Thus, a decorative film was obtained. The releasing sheet for transfer was released and an acrylate resin adhesive was applied to the exposed primer layer, and then the decorative film was integrally bonded to a surface of wooden board as a substrate via the adhesive, followed by removing the protection film. Thus, a decorative board was obtained.

The obtained decorative board had a plating tone finish and had even silver metallic luster when observed from the curable resin layer.

### Example 2

The same process as in Example 1 were applied except that a decorative layer was formed by a vapor deposition method instead of using a spattering process of Example 1. The vacuum degree was set to be 3×10⁻³ Pa and the forming speed was set to be 2 μm/minute. Next, an acrylic adhesive (X-0589 manufactured by VIG TEQNOS LTD) was applied to a primer layer in which a decorative film was exposed and an adhesive layer was formed. This was adhered to a PET substrate thereby obtaining a decorative board. The obtained decorative board had a plating tone finish and had even silver metallic luster as observed in using a spattering process.

### Comparative Example 1

In the manufacturing process of Example 1, a spattering method was applied making acrylic resin which does not contain a cross-linking agent. However, silver building upon a primer layer could not be observed.

### Comparative Example 2

In the manufacturing process of Example 2, a vapor deposition method was applied making acrylic resin which does not contain a cross-linking agent. However, silver building up on a primer layer could not be observed.

As above mentioned, since the present invention provides a decorative film having a design effect with a plating tone which has not been realized by a decorative film disclosed in the Japanese Unexamined Patent Publication 2001-1483 with good workability, better design can be provided. For this reason, the decorative film of the present invention can preferably be used not only for construction components including walls, column, and doors, for billboards or signs as well as exteriors and interiors of vehicles and vessels including automobile mirror parts and bumper parts, or bodies, and the like.

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during-the prosecution of the application, which examples are to be construed as non-exclusive. For example, in the present disclosure, the term “preferably” is non-exclusive and means “preferably, but not limited to.” Means-plus-function or process-plus-function limitations will only be employed where for a specific claim limitation all of the following conditions are present in that limitation: a) “means for” or “process for” is expressly recited; b) a corresponding function is expressly recited; and c) structure, material or acts that support that structure are not recited.

1. A decorative film, comprising:
a primer layer including a cross-linking agent;
a decorative layer formed on the primer layer; and
a curable resin layer formed on the decorative layer,
wherein the decorative layer includes a metal thin film with a thickness of less than 10 μm and the curable resin layer is a layer cured by radiation.

2. The decorative film as recited in claim 1,
wherein the primer layer having a releasing sheet for transfer on the backside thereof contains a resin having a releasing property to the releasing sheet, and
the primer layer with the decorative layer transfers from the releasing sheet to the curable resin layer formed on the backside of the curable resin layer after coating and curing as to cover a surface of the decorative layer.

3. A method for manufacturing a decorative film, comprising:
the first process to print a primer layer on a releasing surface of a releasing sheet for transfer, wherein the primer layer includes a cross-linking agent and a resin having a releasing property to the releasing sheet;
the second process to from a metal thin film with a thickness of less than 10 μm as a decorative layer on the primer layer by either a spattering method or a vacuum evaporation method;
the third process to coat a curable resin coating cured by radiation on the decorative layer formed on the primer layer in a state of applying the releasing sheet thereon; and,
the forth process to transfer the primer layer and the decorative layer from the releasing sheet to the curable resin layer to form a decorative film when the coated curable resin coating is cured to form a cured resin layer.

4. Automobile parts on which the decorative film as recited in claim 1 is adhered.

5. An automobile, comprising an automobile body and a decorative film with a plating toned metallic luster as a decorative coating,
wherein the decorative film comprises:
a primer layer including a cross-linking agent;
a decorative layer having a metal thin film with a thickness of less than 10 μm formed on the primer layer; and
a curable resin layer formed on the decorative layer,
and the decorative film is adhered on a surface of the automobile body in the primer layer side of the decorative film via an adhesive.
